(19) United States
(12) Patent Application Publication
(10) Pub. No.: US 2019/0068939 A1
(43) Pub. Date: Feb. 28, 2019

(54) IMAGE SIGNAL CONVERSION METHOD AND APPARATUS FOR REDUCING IMAGE QUALITY DETERIORATION

(71) Applicants: Electronics and Telecommunications Research Institute, Daejeon (KR); Ulsan National Institute of Science and Technology, Ulsan (KR)

(72) Inventors: Jung Won KANG, Daejeon (KR); Hyun Suk KO, Daejeon (KR); Jin Ho LEE, Daejeon (KR); Dong San JUN, Daejeon (KR); Hui Yong KIM, Daejeon (KR); Young Shin KWAK, Ulsan (KR); Ye Seul BAEK, Dongducheon-si (KR); Jin Soo CHOI, Daejeon (KR)

(73) Assignees: Electronics and Telecommunications Research Institute, Daejeon (KR); Ulsan National Institute of Science and Technology, Ulsan (KR)

(21) Appl. No.: 16/070,532

(22) PCT Filed: Jan. 19, 2017
(86) PCT No.: PCT/KR2017/000660

§ 371 Date: Jul. 17, 2018

(30) Foreign Application Priority Data
Jan. 22, 2016 (KR) 10-2016-0008292

(51) Int. Cl. H04N 9/78; H04N 19/124; H04N 19/132; H04N 19/186

(52) U.S. Cl. CPC H04N 9/78; H04N 19/186; H04N 19/132; H04N 19/124

(57) ABSTRACT

There is provided a method and apparatus for converting an input video to a video format suitable for compressing, or for converting a recovered video to a video format suitable for displaying. An apparatus for converting a video signal according to an embodiment of the present invention may include: a color space conversion part converting a color space of a video signal thereby the video signal is separated into a brightness component and a color component; a transfer function application part selectively applying a transfer function to one of the brightness component and the color component; a quantization part quantizing the video signal including the brightness component and the color component to which the transfer function is selectively applied; and a sampling part sampling the quantized video signal.

### TECHNICAL FIELD

The present invention relates to a method and apparatus for image signal conversion. More particularly, the present invention relates to a method and apparatus for converting a video signal (or an image signal) capable of decreasing degradation in brightness and color of a video and removing a debanding process.

### BACKGROUND ART

In order to compress a video(or an image), a non-compressed original video may be converted in a proper video format that is suitable for compressing. In addition, a recovered video by using a bitstream may be converted in a proper video format that is suitable for displaying. In converting to a proper video format that is suitable for compressing and/or to a proper video format that is suitable for displaying, at least one or more processes of an electro-optical transfer function, an opto-electrical transfer function, color conversion, chroma resampling, quantization, etc. may be performed. Herein, while performing the above process, degradation in brightness and color of the video may occur, thus there is a demand for improvement.

### DISCLOSURE

### Technical Problem

The technical problem of the present invention is to provide an apparatus and method of converting a video signal that is capable of decreasing degradation in brightness and color occurred in a video by selectively applying a transfer function to one of a brightness component and a color component that are separated from the video signal by a color space conversion.

Another technical problem of the present invention is to provide an apparatus and method of converting a video signal capable of removing the debanding process and providing optimum quantization by applying electro-optical/opto-electrical transfer functions while converting the video signal

Technical objects to be achieved by the present invention are not limited to the above-described objects and other technical objects that have not been described will be evidently understood by those skilled in the art from the following description.

### Technical Solution

According to one aspect of the present invention, there is provided an apparatus for converting a video signal. The apparatus for converting the video signal may include: a color space conversion part converting a color space of a video signal thereby separating the video signal into a brightness component and a color component; a transfer function application part selectively applying a transfer function to one of the brightness component and the color component; a quantization part quantizing the video signal including the brightness component and the color component to which the transfer function is selectively applied; and a sampling part sampling the quantized video signal.

Herein, the transfer function application part may apply the transfer function only to the brightness component.

Alternatively, the transfer function application part may apply the transfer function to one of the brightness component and the color component based on selection information.

Meanwhile, the transfer function application part may use an opto-electrical transfer function (OETF) as the transfer function.

Meanwhile, the color space conversion part may convert an XYZ color space video signal to an IPT color space video signal or to a CIECAM02 color space video signal.

According to another aspect of the present invention, there is provided a method for converting a video signal. The method for converting the video signal may include: converting a color space of a video signal, thereby separating the video signal into a brightness component and a color component; selectively applying a transfer function to one of the brightness component and the color component; quantizing the video signal including the brightness component and the color component in which the transfer function is selectively applied; and sampling the quantized video signal.

Herein, in the selective applying of the transfer function, the transfer function may be applied only to the brightness component.

Alternatively, in the selective applying of the transfer function, the transfer function may be selectively applied to one of the brightness component and the color component based on selection information.

Meanwhile, in the selective applying of the transfer function, an opto-electrical transfer function (OETF) may be used as the transfer function.

Meanwhile, in the converting of the color space of the video signal, an XYZ color space video signal may be converted to an IPT color space video signal or to a CIECAM02 color space video signal.

According to still another aspect of the present invention, there is provided an apparatus for converting a video signal. The apparatus for converting the video signal may include: a sampling part sampling a video signal; a dequantization part dequantizing the sampled video signal; an inverse transfer function application part selectively applying an inverse transfer function to one of a brightness component and a color component of the dequantized video signal; and a color space conversion part converting a color space of the video signal including the brightness component and the color component to which the inverse transfer function is selectively applied.

Herein, the inverse transfer function application part may apply the inverse transfer function only to the brightness component.

Alternatively, the inverse transfer function application part may apply the inverse transfer function to one of the brightness component and the color component based on selection information.

Meanwhile, the inverse transfer function application part may use an electro-optical transfer function (EOTF) as the inverse transfer function.

Meanwhile, the color space conversion part may convert the video signal including the brightness component and the color component to which the inverse transfer function is selectively applied to an XYZ color space video signal.

According to still another aspect of the present invention, there is provided a method of converting a video signal. The method of converting the video signal may include: sampling a video signal; dequantizing the sampled video signal; selectively applying an inverse transfer function to one of a brightness component and a color component of the dequantized video signal; and converting a color space of the video signal including the brightness component and the color component to which the inverse transfer function is selectively applied.

Herein, in the selective applying of the inverse transfer function, the inverse transfer function may be applied only to the brightness component

Alternatively, in the selective applying of the inverse transfer function, the inverse transfer function may be selectively applied to one of the brightness component and the color component based on selection information.

Meanwhile, in the selective applying of the inverse transfer function, an electro-optical transfer function (EOTF) may be used as the transfer function.

Meanwhile, in the converting of the color space of the video signal, the video signal including the brightness component and the color component to which the inverse transfer function is selectively applied may be converted to an XYZ color space video signal.

The features briefly summarized above for the present invention are only illustrative aspects of the detailed description of the invention, which will be described later and do not limit the scope of the present invention.

### Advantageous Effects

According to the present invention, degradation in brightness and color of a video may be reduced by selectively applying a transfer function to one of a brightness component and a color component that are separated by using a color space conversion.

In addition, according to the present invention, optimum quantization that removes the debanding process may be provided by applying electro-optical/opto-electrical transfer functions while converting a video signal.

Effects obtainable from the present invention are not limited by the above mentioned effect, and, other unmentioned effects can be clearly understood from the following description by those having ordinary skill in the technical field to which the present invention pertains.

### DESCRIPTION OF DRAWINGS

FIG. 1 is a block diagram of an apparatus for converting a video signal according to an embodiment of the present invention that converts the video signal to a proper video format suitable for compressing.

FIG. 2 is a block diagram of an apparatus for converting a video signal according to an embodiment of the present invention that converts the video signal to a proper video format suitable for displaying.

FIG. 3 is a block diagram showing various implementation method of a transfer function application part according to an embodiment of the present invention.

FIG. 4 is a view showing a conversion process of an IPT color space and an inverse conversion process thereof according to an embodiment of the present invention.

FIG. 5 is a view showing a conversion process of a CIECAM02 color space and an inverse conversion process thereof according to an embodiment of the present invention.

FIG. 6 is a block diagram showing processes of pre-processing, encoding, decoding, and post-processing using the apparatus for converting the video signal according to the embodiment of the present invention.

FIG. 7 is a flowchart showing a method of converting a video signal according to an embodiment of the present invention that converts the video signal to a proper video format suitable for compressing.

FIG. 8 is a flowchart showing a method of converting a video signal according to an embodiment of the present invention that converts the video signal to a proper video format suitable for displaying.

### BEST MODE

An apparatus for converting a video signal according to the present invention may include: a color space conversion part converting a color space of a video signal thereby separating the video signal into a brightness component and a color component; a transfer function application part selectively applying a transfer function to one of the brightness component and the color component; a quantization part quantizing the video signal including the brightness component and the color component to which the transfer function is selectively applied; and a sampling part sampling the quantized video signal.

Herein, the transfer function application part may apply the transfer function only to the brightness component.

Alternatively, the transfer function application part may apply the transfer function to one of the brightness component and the color component based on selection information.

Alternatively, the transfer function application part may use an opto-electrical transfer function (OETF) as the transfer function.

Meanwhile, the color space conversion part may convert an XYZ color space video signal to an IPT color space video signal or to a CIECAM02 color space video signal.

A method for converting a video signal according to the present invention may include: converting a color space of a video signal, thereby separating the video signal into a brightness component and a color component; selectively applying a transfer function to one of the brightness component and the color component; quantizing the video signal including the brightness component and the color component in which the transfer function is selectively applied; and sampling the quantized video signal.

Herein, in the selective applying of the transfer function, the transfer function may be applied only to the brightness component.

Alternatively, in the selective applying of the transfer function, the transfer function may be selectively applied to one of the brightness component and the color component based on selection information.

Meanwhile, in the selective applying of the transfer function, an opto-electrical transfer function (OETF) may be used as the transfer function.

Meanwhile, in the converting of the color space of the video signal, an XYZ color space video signal may be converted to an IPT color space video signal or to a CIECAM02 color space video signal.

An apparatus for converting a video signal according to the present invention may include: a sampling part sampling a video signal; a dequantization part dequantizing the sampled video signal; an inverse transfer function application part selectively applying an inverse transfer function to one of a brightness component and a color component of the dequantized video signal; and a color space conversion part converting a color space of the video signal including the brightness component and the color component to which the inverse transfer function is selectively applied.

Herein, the inverse transfer function application part may apply the inverse transfer function only to the brightness component.

Alternatively, the inverse transfer function application part may apply the inverse transfer function to one of the brightness component and the color component based on selection information.

Meanwhile, the inverse transfer function application part may use an electro-optical transfer function (EOTF) as the inverse transfer function.

Meanwhile, the color space conversion part may convert the video signal including the brightness component and the color component to which the inverse transfer function is selectively applied to an XYZ color space video signal.

A method for converting a video signal according to the present invention may include: sampling a video signal; dequantizing the sampled video signal; selectively applying an inverse transfer function to one of a brightness component and a color component of the dequantized video signal; and converting a color space of the video signal including the brightness component and the color component to which the inverse transfer function is selectively applied.

Herein, in the selective applying of the inverse transfer function, the inverse transfer function may be applied only to the brightness component

Alternatively, in the selective applying of the inverse transfer function, the inverse transfer function may be selectively applied to one of the brightness component and the color component based on selection information.

Meanwhile, in the selective applying of the inverse transfer function, an electro-optical transfer function (EOTF) may be used as the transfer function.

Meanwhile, in the converting of the color space of the video signal, the video signal including the brightness component and the color component to which the inverse transfer function is selectively applied may be converted to an XYZ color space video signal.

### Mode for Invention

Hereinafter, with reference to drawings, embodiments of the present invention are described in detail in a manner that one of ordinary skill in the art may perform the embodiments without undue difficulty. The present invention may be embodied in various forms, and the scope of the present invention is not limited to examples provided herein.

In describing an aspect of the present invention, when it is determined that detailed description of a publicly known technology relating to an aspect of the present disclosure may make the subject matter of an aspect of the present disclosure unnecessarily ambiguous, the detailed description will be omitted. In drawings, parts irrelevant to the description are omitted for the simplicity of explanation, and like reference numerals denote like parts through the whole document.

In the present invention, when an element is mentioned to be “coupled” or “connected” to another element, this may mean that it is directly coupled or connected to the other element, but it is to be understood that yet another element may exist in-between. In addition, unless explicitly stated to the contrary, the words “comprise” “comprises”, or “comprising” used throughout the specification will not be understood as excluding other elements but to imply the inclusion of the other elements.

In the present invention, it will be understood that the terms “first”, “second” etc. are only used to differentiate one component from other components. Unless otherwise noted, the expressions do not limit sequence and/or importance of the corresponding components. Therefore, the ‘first’ component may be named the ‘second’ component without departing from the scope of the present invention and the ‘second’ component may also be similarly named the ‘first’ component.

In the present invention, it is to be understood that the components described in the various embodiments are not necessarily essential components, and some may be optional components. Accordingly, embodiments comprising a subset of the components described in one embodiment are also included within the scope of the present invention. In addition, embodiments that include other elements in addition to those described in the various embodiments are also included within the scope of the present invention

In the present invention, the components that are distinguished from each other are intended to clearly illustrate each feature, and it does not mean that the components are separated. In other words, a plurality of components may be integrated to configure a hardware part or software, or a single component may be divided into multiple hardware parts or software components. Accordingly, unless otherwise noted, integrated or distributed embodiments are also included within the scope of the present invention.

Hereinafter, exemplary embodiments of the present invention will be described in detail with reference to the accompanying drawings.

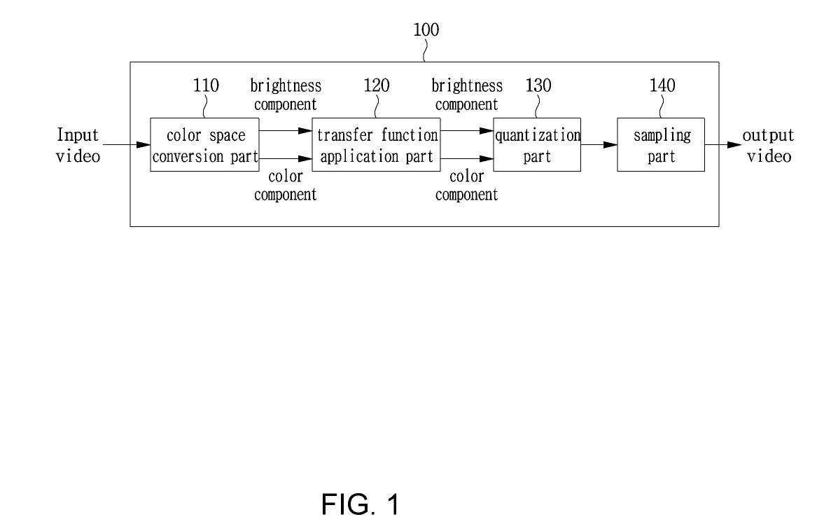

FIG. 1 is a block diagram of an apparatus for converting a video signal 100 according to an embodiment of the present invention that converts the video signal to a proper video format suitable for compressing.

The apparatus for converting the video signal 100 of FIG. 1 may include a color space conversion part 110, a transfer function application part 120, a quantization part 130, and a sampling part 140.

The apparatus for converting the video signal 100 may receive an input video of a high dynamic range (HDR) video. In addition, the input video may be a non-compressed video. Herein, the input video may have a file format such as OpenEXR, TIFF, etc. and may have a color gamut defined from BT.709, BT.2020, P3, etc. In addition, pixel components of the input video may be configured with RGB, YUV, BGR, XYZ, etc., and a pixel configuration thereof may be 4:4:4, 4:2:2, or 4:2:0. When the pixel components of the input video are not configured with XYZ, a configuration that converts the input video to the XYZ pixel components may be added to the apparatus for converting the video signal 100.

The color space conversion part 110 converts a color space of the video signal, thereby the video signal is separated into a brightness component and a color component. In detail, the input video having XYZ pixel components (hereinafter, an XYZ color space video signal) may be converted to a video signal having a color space that is based on a color appearance model such as IPT or CIECAM02 (hereinafter, a IPT color space video signal and a CIECAM02 color space video signal).

The color space conversion part 110 according to an embodiment of the present invention may convert the XYZ color space video signal to the IPT color space video signal. Herein, a brightness component of the IPT color space video signal may be I (light-dark) and color components thereof may be P (red-green) and T (yellow-blue).

Alternatively, the color space conversion part 110 according to the embodiment of the present invention may convert the XYZ color space video signal to the CIECAM02 color space video signal. Herein, a brightness component of the CIECAM02 color space video signal may be A (light-dark) and color components thereof may be a (red-green) and b (yellow-blue).

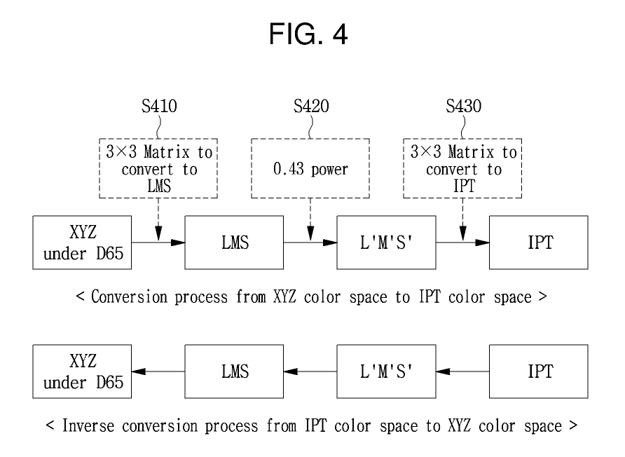

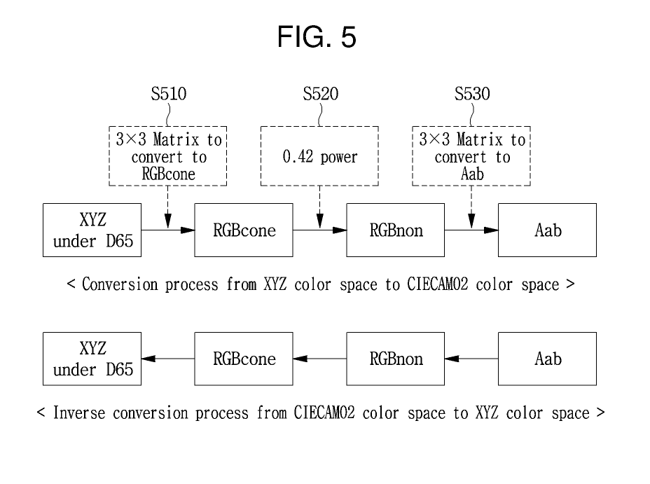

A method of converting the of the XYZ color space video signal to the IPT color space video signal or to the CIECAM02 color space video signal will be described in detail with reference to FIGS. 4 and 5.

The transfer function application part 120 may selectively apply a transfer function to one of the brightness component and the color component. In detail, the transfer function application part 120 may apply the transfer function for optimized quantization in which a visual perception sensitivity for a proper brightness according to a format and/or a characteristic of the video signal is considered.

As the transfer function, an opto-electrical transfer function (OETF) may be used. As the opto-electrical transfer function, one of gamma function, PQ (perceptual quantizer)-OETF, and a hybrid log gamma (HLG) transfer function may be used.

Herein, the transfer function application part 120 may apply the transfer function only to the brightness component of the video signal. The transfer function application part 120 according to an embodiment of the present invention may apply the transfer function only to the brightness component of the video signal since a visual perception sensitivity for a video brightness is considered. A debanding process is minimized while performing quantization by applying the transfer function only to the brightness component considering the visual perception sensitivity for the video brightness.

Alternatively, the transfer function application part 120 may apply the transfer function to one of the brightness component and the color component based on selection information. Herein, the selection information is information for selecting either the brightness component or the color component. The selection information may be set according to the visual perception sensitivity of the video signal.

Hereinafter, a method of applying the transfer function to the brightness component (I or A) of the IPT color space video signal and the CIECAM02 color space video signal will be described with reference to formulas 1 to 5.

Formula 1 is a formula in which the transfer function is applied to the brightness component I of the IPT color space video signal.

$$\begin{matrix}Formula 1 & \\ {I}^{′} = {( \frac{{c}_{1} + {{c}_{2} ( {I}^{1} \text{/} 0.43 )}^{{m}_{1}}}{1 + {{c}_{3} ( {I}^{1} \text{/} 0.43 )}^{{m}_{1}}} )}^{{m}_{2}} & [ Formula 1 ]\end{matrix}$$

Formula 2 is a formula in which the transfer function is applied to the brightness component A of the CIECAM02 color space video signal.

$$\begin{matrix}Formula 2 & \\ {A}^{′} = {( \frac{{c}_{1} + {{c}_{2} ( {A}^{1} \text{/} 0.42 )}^{{m}_{1}}}{1 + {{c}_{3} ( {A}^{1} \text{/} 0.42 )}^{{m}_{1}}} )}^{{m}_{2}} & [ Formula 2 ]\end{matrix}$$

Formula 3 indicates coefficient values of formulas 1 and 2.

$$\begin{matrix}Formula 3 & \\ {m}_{1} = \frac{2610}{4096} \times \frac{1}{4} = 0.1593017578125 , \\ {m}_{2} = \frac{2523}{4096} \times 128 = 78.84375 \\ {c}_{1} = {c}_{3} - {c}_{2} + 1 = \frac{3424}{4096} = 0.8359375 , \\ {c}_{2} = \frac{2413}{4096} \times 32 = 18.8515625 , \\ {c}_{3} = \frac{2392}{4096} \times 32 = 18.6875 & [ Formula 3 ]\end{matrix}$$

Formulas 1 to 3 show embodiments to which the transfer function is applied based on the PQ-OETF.

Meanwhile, when the transfer function in which a visual perception sensitivity for a human video brightness is defined as K′═F(K), the corresponding function may be assumed to be an optimal transfer function that converts to a non-linear brightness component in which a visual perception sensitivity of a linear brightness component is considered.

When such a transfer function is applied to the IPT color space video signal, formula 1 may be generalized as formula 4.

Formula 4

I′═F(I^{1/0.43}) [Formula 4]

In addition, when such a transfer function is applied to the CIECAM02 color space video signal, formula 2 may be generalized as formula 5.

Formula 5

A′=F(A^{1/0.42}) [Formula 5]

The quantization part 130 may perform quantization on the video signal including the brightness component and the color component to which the transfer function is selectively applied. In detail, the quantization part 130 may perform quantization or scaling on each pixel component of the video signal including the brightness component and the color component to which the transfer function is selectively applied in a bit that is used for an input of an encoder. For example, when an Y′ component has 16 bits and the encoder input is 10 bits, the 16 bits of the pixel components are quantized such that the 16 bits are expressed as 10 bits to be used for the encoder input.

The sampling part 140 may resample the quantized video signal. In detail, the sampling part 140 may perform down-sampling on the pixel components to be input to the encoder. For example, when the color format is 4:4:4, the sampling part 140 may perform down-sampling on a chroma signal that has a relatively low sensitivity and the color format thereof is converted to a format 4:2:2 or to a format 4:2:0.

The apparatus for converting the video signal 100 of FIG. 1 may include all of the plurality of components that are described above to convert the video signal or the video format. However, some parts of the plurality of components may be omitted or an order thereof may be changed. In addition, the apparatus for converting the video signal 100 may further include additional component that is not described in the present invention.

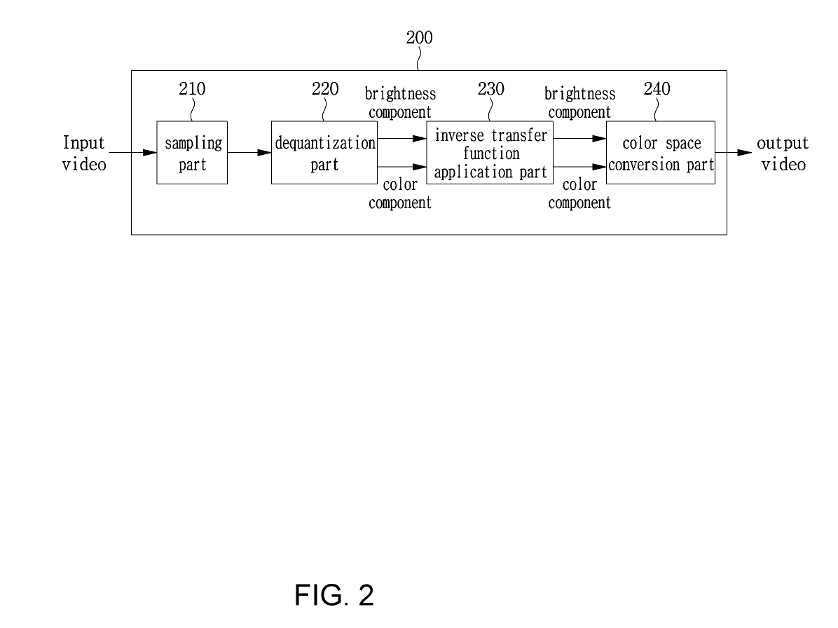

FIG. 2 is a block diagram of an apparatus for converting a video signal 200 according to an embodiment of the present invention that converts the video signal to a proper video format suitable for displaying.

The apparatus for converting the video signal 200 may include a sampling part 210, a dequantization part 220, an inverse transfer function application part 230, and a color space inverse conversion part 240.

An input video of the apparatus for converting the video signal 200 may be a bitstream decoded in a decoder. In addition, an output video of the apparatus for converting the video signal 200 in FIG. 2 may be defined as the same the input video of the apparatus for converting the video signal 100 of FIG. 1.

The sampling part 210 may sample the video signal. In detail, the sampling part 210 may perform up-sampling on pixel components to display the video signal. For example, when a color format is 4:2:0 or 4:2:2, the color format may be converted to a 4:4:4 format by performing up-sampling.

The dequantization part 220 may perform dequantization on the sampled video signal. In detail, the dequantization part 220 may perform inverse-quantization to each pixel component of the sampled video signal such that the sampled video signal is converted to bits suitable for displaying. For example, a pixel value 10 bits or 12 bits is converted by performing inverse-quantization to 16 bits, which is suitable for displaying.

The inverse transfer function application part 230 may selectively apply an inverse transfer function to one of a brightness component and a color component of the dequantized video signal. In detail, the transfer function used in the transfer function application part 120 of FIG. 1 may be used as the inverse transfer function used in the inverse transfer function application part 230. As the inverse transfer function, an electro-optical transfer function (EOTF) may be used.

Alternatively, the inverse transfer function application part 230 may apply the inverse transfer function only to the brightness component.

Alternatively, the inverse transfer function application part 230 may apply the inverse transfer function to one of the brightness component and the color component based on selection information. Herein, the selection information may be transmitted from the encoder with the bitstream.

Hereinafter, a method of applying the inverse transfer function to the brightness component of the video signal will be described with reference to formulas 6 to 8.

Formula 6 is a formula in which the inverse transfer function is applied to a brightness component I′ of the IPT color space video signal.

$$\begin{matrix}Formula 6 & \\ {I}^{1 / 0.43} = {( \frac{max [ ( {I}^{′1 / {m}_{2}} - {c}_{1} ) , 0 ]}{{c}_{2} - {c}_{3} {I}^{′1 / {m}_{2}}} )}^{1 / {m}_{1}} & [ Formula 6 ]\end{matrix}$$

Formula 7 is a formula in which the inverse transfer function is applied to a brightness component A′ of the CIECAM02 color space video signal.

$$\begin{matrix}Formula 7 & \\ {A}^{1 / 0.42} = {( \frac{max [ ( {A}^{′1 / {m}_{2}} - {c}_{1} ) , 0 ]}{{c}_{2} - {c}_{3} {A}^{′1 / {m}_{2}}} )}^{1 / {m}_{1}} & [ Formula 7 ]\end{matrix}$$

Formula 8 indicates coefficient values of formulas 6 and 7.

$$\begin{matrix}Formula 8 & \\ {m}_{1} = \frac{2610}{4096} \times \frac{1}{4} = 0.1593017578125 , \\ {m}_{2} = \frac{2523}{4096} \times 128 = 78.84375 \\ {c}_{1} = {c}_{3} - {c}_{2} + 1 = \frac{3424}{4096} = 0.8359375 , \\ {c}_{2} = \frac{2413}{4096} \times 32 = 18.8515625 , \\ {c}_{3} = \frac{2392}{4096} \times 32 = 18.6875 & [ Formula 8 ]\end{matrix}$$

The color space inverse conversion part 240 may convert the video signal including the brightness component and the color component to which the inverse transfer function is selectively applied. In detail, the color space inverse conversion part 240 may convert the IPT color space video signal or the CIECAM02 color space video signal to an XYZ color space video signal.

A method of converting the IPT color space video signal or the CIECAM02 color space video signal to the XYZ color space video signal will be described in detail with reference to FIGS. 4 and 5.

The apparatus for converting the video signal 200 of FIG. 2 may include all of the plurality of components that are described above to convert the video signal or the video format. However, some parts of the plurality of components may be omitted or an order thereof may be changed. In addition, the apparatus for converting the video signal 100 may further include additional components that are not described in the present invention

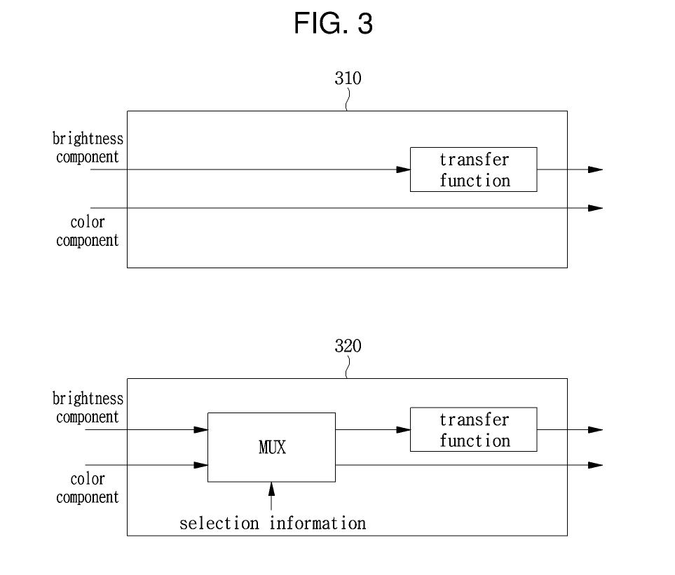

FIG. 3 is a block diagram showing various implementation examples of a transfer function application part that constitutes the apparatus for converting the video signal according to the embodiment of the present invention.

A transfer function application part 310 according to an embodiment of the present invention may apply a transfer function only to a brightness component of a video signal. The transfer function according to the embodiment of the present invention may be applied only to the brightness component among color components since a visual perception sensitivity for a video brightness is considered. A debanding process while performing quantization is minimized by applying the transfer function only to the brightness component in which the visual perception sensitivity is considered.

Alternatively, a transfer function application part 320 according to another embodiment of the present invention may selectively apply a transfer function to one of a brightness component and a color component based on selection information. Herein, one of the brightness component and the color component is selected by inputting the selection information to a multiplexer, the transfer function is applied to the selected component, and the component that is not selected is bypassed without being applied to the transfer function.

FIG. 3 shows the transfer function application parts with reference to the transfer function application part 120 of FIG. 1. However, the transfer function may be changed to the inverse transfer function and applied to the inverse transfer function 230 of FIG. 2. Herein, the selection information is transmitted from the encoder with the bitstream.

FIG. 4 is a view showing a conversion process of an IPT color space and an inverse conversion process thereof according to an embodiment of the present invention. Hereinafter, the conversion process of the IPT color space and the inverse conversion process thereof will be described with reference to FIG. 4.

[1] Conversion process from an XYZ color space to an IPT color space

1. Step of normalizing XYZ considering a video signal transfer function to which debanding quantization is applied

For example, when the transfer function supports up to the maximum brightness 10,000 nits, XYZ may be normalized to 10,000 nits by using the below formula 9

Formula 9

X═X/10,000, Y═Y/10,000, Z═Z/10,000 [Formula 9]

For example, when the transfer function supports up to the maximum brightness P nits, XYZ may be normalized to P nits by using the below formula 10

Formula 10

X═X/P, Y═Y/P, Z═Z/P [Formula 10]

[2] Step of converting XYZ to linear RGB

In converting XYZ to linear RGB, when a color gamut of a signal to be converted is BT.709 as the below formula 11, the signal may be converted by using M_{RGB}_{_}_{7C9}. Alternatively, when the color gamut of the signal to be converted is BT.2020, the signal may be converted by using M_{RGB}_{_}_{202C}.

$$\begin{matrix}Formula 11 & \\ [ \begin{matrix}R \\ G \\ B\end{matrix} ] = {M}_{RGB} \cdot [ \begin{matrix}X \\ Y \\ Z\end{matrix} ] \\ {M}_{RGB\_ 709} = [ \begin{matrix}0.4124 & 0.3576 & 0.1805 \\ 0.2126 & 0.7152 & 0.0722 \\ 0.0193 & 0.1192 & 0.9505\end{matrix} ] \\ {M}_{RGB\_ 3020} = [ \begin{matrix}0.6370 & 0.1446 & 0.1689 \\ 0.2627 & 0.0678 & 0.0593 \\ 0.0000 & 0.0281 & 1.0610\end{matrix} ] & [ Formula 11 ]\end{matrix}$$

3. Step of converting linear RGB to linear LMS (S410)

Linear RGB may be converted to linear LMS by using the below formula 12.

$$\begin{matrix}Formula 12 & \\ [ \begin{matrix}L \\ M \\ S\end{matrix} ] = [ \begin{matrix}0.4102 & 0.5239 & 0.0641 \\ 0.1667 & 0.7204 & 0.1129 \\ 0.0241 & 0.0755 & 0.9004\end{matrix} ] \cdot [ \begin{matrix}R \\ G \\ B\end{matrix} ] & [ Formula 12 ]\end{matrix}$$

4. Step of converting linear LMS to L′M′S′ that is non-linear LMS (S420)

The present step is to reflect a perception characteristic, linear LMS may be converted to L′M′S′ that is non-linear LMS by using the below formula 13.

$$\begin{matrix}Formula 13 & \\ \begin{matrix}{L}^{′} = {L}^{0.43} , & L \geq 0 \\ {L}^{′} = - {\vert L \vert}^{0.43} , & L \leq 0\end{matrix} \begin{matrix}{M}^{′} = {M}^{0.43} , & M \geq 0 \\ {M}^{′} = - {\vert M \vert}^{0.43} , & M \leq 0\end{matrix} \\ \begin{matrix}{S}^{′} = {S}^{0.43} , & S \geq 0 \\ {S}^{′} = - {\vert S \vert}^{0.43} , & S \leq 0\end{matrix} & [ Formula 13 ]\end{matrix}$$

5. Step of converting L′M′S′ that is non-linear LMS to IPT (S430)

By using the below formula 12, L′M′S′ that is non-linear LMS may be converted to IPT. Herein, I component indicates a light-dark signal, P component indicates red-green signal, and T component indicates a yellow-blue signal.

$$\begin{matrix}Formula 14 & \\ [ \begin{matrix}I \\ P \\ T\end{matrix} ] = [ \begin{matrix}0.5000 & 0.5000 & 0.0000 \\ 1.6137 & - 3.3234 & 1.7097 \\ 4.3781 & - 4.2455 & - 0.1325\end{matrix} ] \cdot [ \begin{matrix}{L}^{′} \\ {M}^{′} \\ {S}^{′}\end{matrix} ] & [ Formula 14 ]\end{matrix}$$

[2] Conversion process from an IPT color space to an XYZ color space (inverse conversion process)

1. Step of converting IPT to L′M′S′ that is non-linear LMS

IPT may be converted to L′M′S′ that is non-linear LMS by using the below formula 15.

$$\begin{matrix} Formula 15 & \\ [ \begin{matrix}{L}^{′} \\ {M}^{′} \\ {S}^{′}\end{matrix} ] = {[ \begin{matrix}0.5000 & 0.5000 & 0.0000 \\ 1.6137 & - 3.3234 & 1.7097 \\ 4.3781 & - 4.2455 & - 0.1325\end{matrix} ]}^{- 1} \cdot [ \begin{matrix}I \\ P \\ T\end{matrix} ] = [ \begin{matrix}1.0000 & 0.0086 & 0.1110 \\ 1.0000 & - 0.0086 & - 0.1110 \\ 1.0000 & 0.5600 & - 0.3206\end{matrix} ] \cdot [ \begin{matrix}I \\ P \\ T\end{matrix} ] & [ Formula 15 ]\end{matrix}$$

2. Step of converting L′M′S′ that is non-linear LMS to linear LMS

L′M′S′ that is non-linear LMS may be converted to linear LMS by using the below formula 16.

Formula 16

L=L′^{1/0/43}M═M′^{1/0/43}S═S′^{1/0/43} [Formula 16]

3. Step of converting linear LMS to linear RGB

Linear LMS may be converted linear to RGB by using the below formula 17.

$$\begin{matrix} Formula 17 & \\ [ \begin{matrix}R \\ G \\ B\end{matrix} ] = {[ \begin{matrix}0.4102 & 0.5239 & 0.0641 \\ 0.1667 & 0.7204 & 0.1129 \\ 0.0241 & 0.0755 & 0.9004\end{matrix} ]}^{- 1} \cdot [ \begin{matrix}L \\ M \\ S\end{matrix} ] = [ \begin{matrix}3.4590 & - 2.5228 & 0.0701 \\ - 0.7964 & 1.9874 & - 0.1925 \\ - 0.0258 & - 0.0991 & 1.1249\end{matrix} ] \cdot [ \begin{matrix}L \\ M \\ S\end{matrix} ] & [ Formula 17 ]\end{matrix}$$

4. Step of converting linear RGB to XYZ

Linear RGB may be converted XYZ by using the below formula 18.

$$\begin{matrix}Formula 18 & \\ [ \begin{matrix}X \\ Y \\ Z\end{matrix} ] = {M}_{RGB}^{- 1} \cdot [ \begin{matrix}R \\ G \\ B\end{matrix} ] \\ {M}_{RGB\_ 709}^{- 1} = [ \begin{matrix}3.2406 & - 1.5372 & - 0.4986 \\ - 0.9689 & 1.8758 & 0.0415 \\ 0.0557 & - 0.2040 & 1.0570\end{matrix} ] \\ {M}_{RGB\_ 2 \; 020}^{- 1} = [ \begin{matrix}12.3175 & - 26.0610 & - 0.5042 \\ - 48.8574 & 118.4704 & 1.1562 \\ 1.2940 & - 3.1376 & 0.9119\end{matrix} ] & [ Formula 18 ]\end{matrix}$$

5. Step of recovering from the normalized XYZ to original video signal in which a video signal transfer function is considered for debanding quantization within the conversion process

For example, when the transfer function supports up to the maximum brightness 10,000 nits, XYZ may be normalized to 10,000 nits by using the below formula 19.

Formula 19

X═X*10,000, Y═Y*10,000, Z═Z*10,000 [Formula 19]

For example, when the transfer function supports up to the maximum brightness P nits, XYZ may be normalized to P nits by using the below formula 20.

Formula 20

X═X*P, Y═Y*P, Z═Z*P [Formula 20]

The conversion process and the inverse conversion process of the IPT color space may be performed by the above steps.

FIG. 5 is a view showing a conversion process of a CIECAM02 color space and an inverse conversion process thereof according to an embodiment of the present invention. Hereinafter, the conversion process and the inverse conversion process of the CIECAM02 color space will be described with reference to FIG. 5.

[1] Conversion process from an XYZ color space to a CIECAM02 color space

1. Step of normalizing XYZ considering a video signal transfer function to which debanding quantization is applied

For example, when the transfer function supports up to the maximum brightness 10,000 nits, XYZ may be normalized to 10,000 nits by using the below formula 21.

Formula 21

X═X/10,000, Y═Y/10,000, Z═Z/10,000 [Formula 21]

For example, when the transfer function supports up to the maximum brightness P nits, XYZ may be normalized to P nits by using the below formula 22.

Formula 22

X═X/P, Y═Y/P, Z═Z/P [Formula 22]

2. Step of converting XYZ to RGBcone (S510)

In converting XYZ to RGBcone, when a white dot of a signal to be converted is assumed to be D65, a transfer function may be the below formula 23.

$$\begin{matrix}Formula 23 & \\ [ \begin{matrix}{R}_{cone} \\ {G}_{cone} \\ {B}_{cone}\end{matrix} ] = [ \begin{matrix}0.4239 & 0.6933 & - 0.0884 \\ - 0.2037 & 1.1537 & 0.0367 \\ - 0.0008 & - 0.0010 & 0.9200\end{matrix} ] \cdot [ \begin{matrix}X \\ Y \\ Z\end{matrix} ] & [ Formula 23 ]\end{matrix}$$

3. Step of converting RGBcone to RGBnon that is non-linear RGBcone (S520)

RGBcone may be converted to RGBnon that is non-linear RGBcone by using the below formula 24.

Formula 24

Rₙₒₙ═R_{cone}^{0.42}Gₙₒₙ=G_{cone}^{0.42}Bₙₒₙ=B_{cone}^{0.42} [Formula 24]

4. Step of converting RGBnon that is non-linear RGBcone to Aab that is CIECAM02 color space (S530)

RGBnon that is non-linear RGBcone may be converted to Aab that is a CIECAM02 color space by using the below formula 25. Herein, A component indicates a component of light-dark signal, a component indicates a component of red green signal, and b component indicates a component of yellow-blue signal.

$$\begin{matrix}Formula 25 & \\ [ \begin{matrix}A \\ a \\ b\end{matrix} ] = [ \begin{matrix}0.6557 & 0.3279 & 0.0164 \\ 3.3333 & - 3.6364 & 0.3030 \\ 0.3704 & 0.3704 & - 0.7407\end{matrix} ] \cdot [ \begin{matrix}{R}_{non} \\ {G}_{non} \\ {B}_{non}\end{matrix} ] & [ Formula 25 ]\end{matrix}$$

[2] Conversion process from a CIECAM02 color space to an XYZ color space (inverse conversion process)

1. Step of converting Aab that is CIECAM02 color space to RGBnon that is non-linear RGBcone

Aab that is a CIECAM02 color space may be converted to RGBnon that is non-linear RGBcone by using the below formula 26.

$$\begin{matrix} Formula 26 & \\ [ \begin{matrix}{R}_{non} \\ {G}_{non} \\ {B}_{non}\end{matrix} ] = {[ \begin{matrix}0.6557 & 0.3279 & 0.0164 \\ 3.3333 & - 3.6364 & 0.3030 \\ 0.3704 & 0.3704 & - 0.7407\end{matrix} ]}^{- 1} \cdot [ \begin{matrix}A \\ a \\ b\end{matrix} ] = [ \begin{matrix}1.0000 & 0.0964 & 0.0616 \\ 1.0000 & - 0.1905 & - 0.0558 \\ 1.0001 & - 0.0470 & - 1.3472\end{matrix} ] \cdot [ \begin{matrix}A \\ a \\ b\end{matrix} ] & [ Formula 26 ]\end{matrix}$$

2. Step of converting RGBnon that is non-linear RGBcone to linear RGBcone

RGBnon that is non-linear RGBcone may be converted to linear RGBcone by using the below formula 27.

Formula 27

R_{cone}═Rₙₒₙ^{1/0.42}, G_{cone}=Gₙₒₙ^{1/0.42}, B_{cone}═Bₙₒₙ^{1/0.42} [Formula 27]

3. Step of converting linear RGBcone to XYZ

Linear RGBcone may be converted to XYZ by using the below formula 28.

$$\begin{matrix} Formula 28 & \\ [ \begin{matrix}X \\ Y \\ Z\end{matrix} ] = {[ \begin{matrix}0.4239 & 0.6933 & - 0.0884 \\ - 0.2037 & 1.1537 & 0.0367 \\ - 0.0008 & - 0.0010 & 0.9200\end{matrix} ]}^{- 1} \cdot [ \begin{matrix}{R}_{cone} \\ {G}_{cone} \\ {B}_{cone}\end{matrix} ] = [ \begin{matrix}1.8308 & - 1.100 & 0.2197 \\ 0.3231 & 0.6727 & 0.0042 \\ 0.0019 & - 0.0002 & 1.0871\end{matrix} ] \cdot [ \begin{matrix}{R}_{cone} \\ {G}_{cone} \\ {B}_{cone}\end{matrix} ] & [ Formula 28 ]\end{matrix}$$

4. Step of recovering from the normalized XYZ to original video signal in which a video signal transfer function is considered for debanding quantization within the conversion process

For example, when the transfer function supports up to the maximum brightness 10,000 nits, XYZ may be normalized to 10,000 nits by using the below formula 29.

Formula 29

X═X*10,000, Y═Y*10,000, Z═Z*10,000 [Formula 29]

For example, when the transfer function supports up to the maximum brightness P nits, XYZ may be normalized to P nits by using the below formula 30.

Formula 30

X═X*P, Y═Y*P, Z═Z*P [Formula 30]

The conversion process and the inverse conversion process of the CIECAM02 color space may be performed by the above steps.

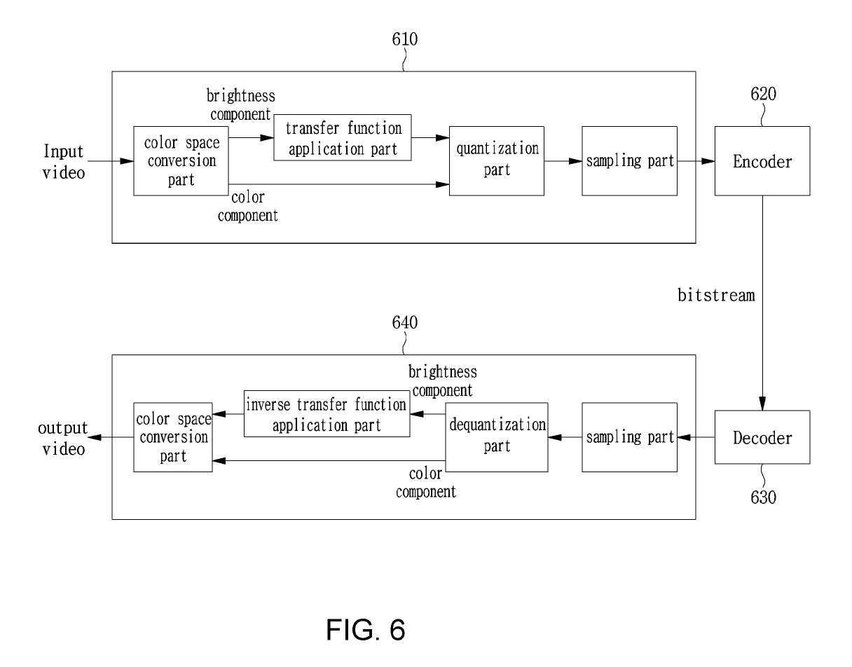

FIG. 6 is a block diagram showing processes of a pre-processing, encoding, decoding, and a post-processing using the apparatus for converting the video signal according to the embodiment of the present invention.

Referring to FIG. 6, a first apparatus for converting a video signal 610 may be a pre-processor disposed in front of an encoder 620 to converts the video signal to a proper video format that is suitable for compressing by the encoder 620. Herein, the first apparatus for converting the video signal 610 functioning as the pre-processor may be the apparatus for converting the video signal 100 of FIG. 1.

A second apparatus for converting a video signal 640 may be a post-processor disposed in the rear end of a decoder 630 to convert a decoded video signal to a video format that is suitable for displaying. Herein, the second apparatus for converting the video signal 640 functioning as the post-processor may be the apparatus for converting the video signal 200 of FIG. 2.

Herein, the encoder 620 and/or the decoder 630 may refer to all kinds of codecs that perform video encoding and/or video decoding. For example, the codecs may correspond to one of a video compression codec such as MPEG, AVC, HEVC, SHVC, but it is not limited thereto.

Alternatively, the first apparatus for converting the video signal 610 functioning as the pre-processor and/or the second apparatus for converting the video signal 640 functioning as the post-processor may respectively be a part of the encoder and/or decoder and performed therein.

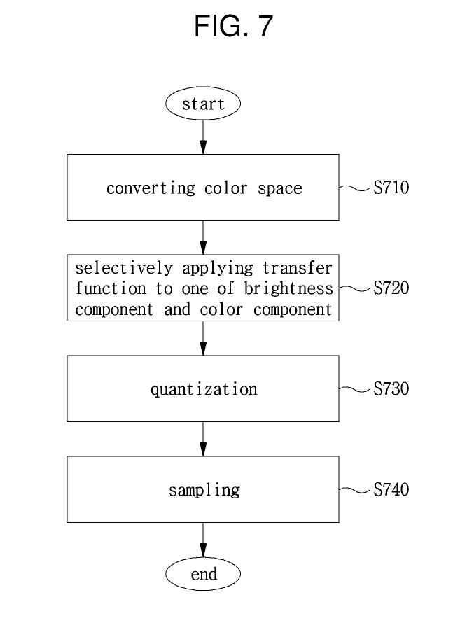

FIG. 7 is a flowchart showing a method of converting a video signal according to an embodiment of the present invention that converts the video signal to a proper video format suitable for suitable compressing. It is assumed that the method of converting the video signal is performed by the apparatus for converting the video signal 100 of FIG. 1.

Referring to FIG. 7, in step S710, the apparatus for converting the video signal may convert a color space of the video signal thereby the video signal is separated into a brightness component and a color component.

Herein, the apparatus for converting the video signal may convert a XYZ color space video signal to an IPT color space video signal or to a CIECAM02 color space video signal.

Then, in step S720, the apparatus for converting the video signal may selectively apply a transfer function to one of the brightness component and the color component that are separated in step S710.

Herein, the apparatus for converting the video signal may use an optical-electro transfer function (OETF) as the transfer function.

Alternatively, the apparatus for converting the video signal may apply the transfer function only to the brightness component of the video signal.

Alternatively, the apparatus for converting the video signal may apply the transfer function to one of the brightness component and the color component based on selection information.

Then, in step S730, the apparatus for converting the video signal may perform quantization on the video signal including the brightness component and the color component to which the transfer function is selectively applied in step S720.

Then, in step S740, the apparatus for converting the video signal may sample the video signal quantized in step S730.

The method of converting the video signal of FIG. 7 may be performed not only by the apparatus for converting the video signal 100 of FIG. 1 but also by another processor included in an encoder.

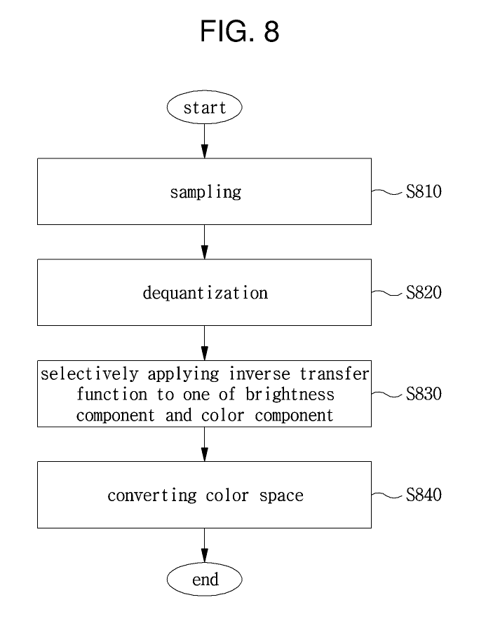

FIG. 8 is a flowchart showing a method of converting a video signal according to an embodiment of the present invention that converts the video signal to a proper video format suitable for displaying. It is assumed that the method of converting the video signal is performed by the apparatus for converting the video signal 200 of FIG. 2.

Referring to FIG. 8, in step S810, the apparatus for converting the video signal may sample the video signal.

Then, in step S820, the apparatus for converting the video signal may perform dequantization on the video signal sampled in step S810.

Then, in step S830, the apparatus for converting the video signal may selectively apply an inverse transfer function to one of a brightness component and a color component of the video signal dequantized in step S820.

Herein, the apparatus for converting the video signal may use an electro-optical transfer function (EOTF) as the inverse transfer function.

Alternatively, the apparatus for converting the video signal may apply the inverse transfer function only to the brightness component of the video signal.

Alternatively, the apparatus for converting the video signal may apply the inverse transfer function to one of the brightness component and the color component based on selection information.

Then, in step S840, the apparatus for converting the video signal may convert a color space of the video signal including the brightness component and the color component to which the inverse transfer function is selectively applied in step S830.

Herein, the apparatus for converting the video signal may convert the IPT color space video signal or the CIECAM02 color space video signal to an XYZ color space video signal.

The method of converting the video signal of FIG. 8 may be performed not only by the apparatus for converting the video signal 200 of FIG. 2 but also by another processor included in a decoder.

However, in order to implement a method of converting a video signal according to one aspect of the present invention, there may be provided a software or a computer-readable medium including executable instructions. The executable instructions may include: converting a color space of a video signal, thereby separating the video signal into a brightness component and a color component; selectively applying a transfer function to one of the brightness component and the color component; quantizing the video signal including the brightness component and the color component in which the transfer function is selectively applied; and sampling the quantized video signal.

In addition, the executable instructions may include: sampling a video signal; dequantizing the sampled video signal; selectively applying an inverse transfer function to one of a brightness component and a color component of the dequantized video signal; and converting a color space of the video signal including the brightness component and the color component to which the inverse transfer function is selectively applied.

The present invention relates to a video signal conversion technique, whereby an input video is converted from HDR input video to a proper video format suitable for compressing in a pre-processing process of video compressing and a recovered video after a post-processing process of video compressing is converted to a proper video format suitable for displaying, degradation in brightness and color of the video may be reduced by selectively applying a transfer function to one of a brightness component and a color component that are separated by using a color space conversion.

In addition, optimized quantization in which a debanding process is removed may be provided by applying electro-optical/opto-electrical transfer functions.

While the exemplary method of the present invention is described as a series of operations, for clarity of description, this does not limit the order of steps. When needed, the steps may be performed at the same time or in a different order. In order to implement the method according to the present invention, the exemplary method may further include additional steps, include the remaining steps except for some steps, or may include additional steps other than some steps.

Various embodiments of the present invention are intended to illustrate representative aspects of the present invention rather than listing all possible combinations, and those described in the various embodiments may be applied independently or in a combination of two or more.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), general processors, controllers, micro-controllers, microprocessors, electronic devices, other electronic units designed to perform the functions described herein, or a combination thereof.

The scope of the present invention includes a software or machine executable instructions (for example, operating system, application, firmware, program, etc.) for enabling to implement operations according to the methods of the various embodiments, and a device or a non-transitory computer-readable medium executable on a computer storing such a software or instructions.

### INDUSTRIAL APPLICABILITY

The present invention may be used for converting a video signal.

1. An apparatus for converting a video signal, the apparatus comprising:
a color space conversion part converting a color space of a video signal thereby separating the video signal into a brightness component and a color component;
a transfer function application part selectively applying a transfer function to one of the brightness component and the color component;
a quantization part quantizing the video signal including the brightness component and the color component to which the transfer function is selectively applied; and
a sampling part sampling the quantized video signal.

2. The apparatus of claim 1, wherein the transfer function application part applies the transfer function only to the brightness component.

3. The apparatus of claim 1, wherein the transfer function application part applies the transfer function to one of the brightness component and the color component based on selection information.

4. The apparatus of claim 1, wherein the transfer function application part uses an opto-electrical transfer function (OETF) as the transfer function.

5. The apparatus of claim 1, wherein the color space conversion part converts an XYZ color space video signal to a IPT color space video signal or to a CIECAM02 color space video signal.

6. A method of converting a video signal, the method comprising:
converting a color space of a video signal, thereby separating the video signal into a brightness component and a color component;
selectively applying a transfer function to one of the brightness component and the color component;
quantizing the video signal including the brightness component and the color component to which the transfer function is selectively applied; and
sampling the quantized video signal.

7. The method of claim 6, wherein in the selective applying of the transfer function, the transfer function is applied only to the brightness component.

8. The method of claim 6, wherein in the selective applying of the transfer function, the transfer function is selectively applied to one of the brightness component and the color component based on selection information.

9. The method of claim 6, wherein in the selective applying of the transfer function, an opto-electrical transfer function (OETF) is used as the transfer function.

10. The method of claim 6, wherein in the converting of the color space of the video signal, an XYZ color space video signal is converted to an IPT color space video signal or to a CIECAM02 color space video signal.

11. An apparatus for converting a video signal, the apparatus comprising:
a sampling part sampling a video signal;
a dequantization part dequantizing the sampled video signal;
an inverse transfer function application part selectively applying an inverse transfer function to one of a brightness component and a color component of the dequantized video signal; and
a color space conversion part converting a color space of the video signal including the brightness component and the color component to which the inverse transfer function is selectively applied.

12. The apparatus of claim 11, wherein the inverse transfer function application part applies the inverse transfer function only to the brightness component.

13. The apparatus of claim 11, wherein the inverse transfer function application part applies the inverse transfer function to one of the brightness component and the color component based on selection information.

14. The apparatus of claim 11, wherein the inverse transfer function application part uses an electro-optical transfer function (EOTF) as the inverse transfer function.

15. The apparatus of claim 11, wherein the color space conversion part converts the video signal including the brightness component and the color component to which the inverse transfer function is selectively applied to an XYZ color space video signal.

16. A method for converting a video signal, the method comprising:
sampling a video signal;
dequantizing the sampled video signal;
selectively applying an inverse transfer function to one of a brightness component and a color component of the dequantized video signal; and
converting a color space of the video signal including the brightness component and the color component to which the inverse transfer function is selectively applied.

17. The method of claim 16, wherein in the selective applying of the inverse transfer function, the inverse transfer function is applied only to the brightness component.

18. The method of claim 16, wherein in the selective applying of the inverse transfer function, the inverse transfer function is selectively applied to one of the brightness component and the color component based on selection information.

19. The method of claim 16, wherein in the selective applying of the inverse transfer function, an electro-optical transfer function (EOTF) is used as the transfer function.

20. The method of claim 16, wherein in the converting of the color space of the video signal, the video signal including the brightness component and the color component to which the inverse transfer function is selectively applied is converted to an XYZ color space video signal.
